(19) United States
(12) Patent Application Publication
(10) Pub. No.: US 2002/0135549 A1
(43) Pub. Date: Sep. 26, 2002

(54) Electro-optical apparatus and electronic unit

(76) Inventor: Hirotaka Kawata, Nagano-ken (JP)

Correspondence Address: Oliff & Berridge, PO Box 19928, Alexandria, VA, 22320, US

(21) Appl. No.: 09/890,952

(22) PCT Filed: Mar. 9, 2001
(86) PCT No.: PCT/JP01/01891

(30) Foreign Application Priority Data
Mar. 10, 2000 (JP) 2000-067387
Sep. 21, 2000 (JP) 2000-287545

(51) Int. Cl. G09G 3/36

(52) U.S. Cl. 345/87

(57) ABSTRACT

An appropriate breakdown voltage between the source and drain of a transistor device covered with an insulating film is obtained. Even when the transistor device is used in a pixel area of an electro-optical apparatus, a sufficient aperture ratio is obtained. In addition, to prevent a reduction in the display quality of the electro-optical apparatus caused by an optical leakage current due to light incident on the transistor device, a p-type transistor having a semiconductor layer about 30 nm to 100 nm thick and a fully-depleted channel layer is used as a transistor connected to a pixel electrode in the electro-optical apparatus.

### TECHNICAL FIELD

The present invention relates to electro-optical apparatuses in which a semiconductor layer is formed on a substrate, and to electronic units using the electro-optical apparatuses. More particularly, the present invention relates to an electro-optical apparatus in which transistors constituting pixels are fully-depleted, p-type transistors, and to an electronic unit using the electro-optical apparatus.

### BACKGROUND ART

Since SOI (silicon on insulator) technology, in which a semiconductor layer made from a monocrystalline silicon layer is formed on an insulating substrate and a semiconductor device such as a transistor is formed in the semiconductor layer, has the advantages of high-speed device operation, lower power consumption, and high integration, this technology can be applied to electro-optical apparatuses such as a supporting substrate in which a TFT array is formed in a liquid-crystal apparatus.

In liquid-crystal apparatuses using general TFT arrays, since a light-shielding layer made of a metal or a resin is formed above an opposed substrate and a TFT array, a malfunction of the TFT array caused by an optical leakage current due to incident light is prevented.

When high-performance TFTs are formed on a monocrystalline silicon layer by using the SOI technology in electro-optical apparatuses, including such liquid-crystal apparatuses, however, the optical-electromotive-force capability of the monocrystalline silicon layer causes an optical leakage current to flow through the TFTs due to stray light passing between layers where light cannot be blocked only by a normal light-shielding layer. If such a TFT is used as a switching device for driving a pixel of the liquid-crystal apparatus, a voltage applied to the liquid crystal of a pixel section fluctuates due to the optical leakage current, and display quality largely deteriorates with flickering. Such a problem of optical leakage current is more severe in liquid-crystal apparatuses on which stronger light is incident than in direct-view types, specifically, in liquid-crystal apparatuses used for light valves in projection-type projectors.

When a transistor is completely separated by an insulating oxide film, the channel region of the transistor cannot be fixed to a predetermined potential, and therefore the channel region is electrically floating. Especially when the transistor is a high-performance TFT, as described above, and an n-type transistor in which electrons serve as carriers, since the carriers move in the channel with a high mobility, a phenomenon called impact ionization occurs due to the collision with the crystal lattice of the carriers accelerated in an electric field disposed in the vicinity of the drain region, thus generating pairs of electrons and positive holes. Positive holes are accumulated at the lower part of the channel in the n-type TFT. When the positive-hole charges are accumulated in the channel in this way, since the NPN (in an n-channel type) structure of the TFT nominally operates as a bipolar transistor, the breakdown voltage between the source and the drain of the device is lowered due to an unusual current and other electrical characteristics deteriorate. A series of phenomena caused by the condition in which these channel sections are electrically floating is called a substrate floating effect.

The present invention has been made in consideration of the above conditions. An object of the present invention is to prevent the deterioration of display quality caused by an optical leakage current in a transistor which cannot be avoided only by a conventional light-shielding layer. Another object is to prevent the deterioration of the breakdown voltage between the source and the drain, caused by the substrate floating effect, of a transistor made from a monocrystalline silicon layer covered with an insulating layer. Still another object is to make stable and improve the electric characteristics of a device and to provide an electro-optical apparatus and an electronic unit which allow a transmissive electro-optical apparatus to have an appropriate aperture ratio.

### DISCLOSURE OF THE INVENTION

To achieve the foregoing objects, an electro-optical apparatus according to a first aspect of the present invention is an electro-optical apparatus having a plurality of scanning lines, a plurality of data lines which intersect with the plurality of scanning lines, a transistor connected to each scanning line and to each data line, and a pixel electrode connected to the transistor on a substrate in which a semiconductor layer is formed on a supporting substrate through an insulating film, characterized in that the transistor is a p-type transistor having a fully-depleted channel layer.

According to the structure of the present invention, even when the semiconductor layer is made from a monocrystalline silicon layer having a high carrier mobility, for example, positive holes serve as carriers in a p-type transistor and the mobility thereof is about one third that of electrons. Therefore, a generation of pairs of electrons and positive holes can be suppressed. Consequently, there is no need to form a body contact, which fixes the potential of the channel, and a high aperture ratio is obtained at a pixel area. In addition, when a fully-depleted channel layer, which has a thin semiconductor layer, is used, since only a few pairs of electrons and positive holes are generated due to light in the semiconductor layer, optical leak is prevented and the display quality of the electro-optical apparatus is improved.

To achieve the foregoing objects, an electro-optical apparatus according to a second aspect of the present invention is an electro-optical apparatus having integrated peripheral circuits, a plurality of scanning lines, a plurality of data lines which intersect with the plurality of scanning lines, a transistor connected to each scanning line and to each data line, and a pixel electrode connected to the transistor on a substrate in which a semiconductor layer is formed on a supporting substrate through an insulating film, characterized in that the peripheral circuits are formed of transistors having partially-depleted channel layers, and the transistor connected to the pixel electrode is a p-type transistor having a fully-depleted channel layer.

According to the structure of the present invention, even when the semiconductor layer is made from a monocrystalline silicon layer having a high carrier mobility, for example, with the use of p-type transistors, a generation of pairs of electrons and positive holes can be suppressed. Therefore, there is no need to form a body contact, which fixes the potential of the channel, and a high aperture ratio is obtained at a pixel area. In addition, when a fully-depleted channel layer, which has a thin semiconductor layer, is used, since only a few pairs of electrons and positive holes are generated due to light in the semiconductor layer, optical leak is prevented and the display quality of the electro-optical apparatus is improved. Further, when partially-depleted transistors are used in the peripheral circuits, a high current is easier to obtain at a circuit portion where a current driving capability is required.

To achieve the foregoing objects, an electro-optical apparatus according to a third aspect of the present invention is an electro-optical apparatus having integrated peripheral circuits, a plurality of scanning lines, a plurality of data lines which intersect with the plurality of scanning lines, a transistor connected to each scanning line and to each data line, and a pixel electrode connected to the transistor on a substrate in which a semiconductor layer is formed on a supporting substrate through an insulating film, characterized in that the peripheral circuits are formed of a combination of transistors having partially-depleted channel layers and of transistors having fully-depleted channel layers, and the transistor connected to the pixel electrode is a p-type transistor having a fully-depleted channel layer.

According to the structure of the present invention, even when the semiconductor layer is made from a monocrystalline silicon layer having a high carrier mobility, for example, with the use of p-type transistors, a generation of pairs of electrons and positive holes can be suppressed. Therefore, there is no need to form a body contact, which fixes the potential of the channel, and a high aperture ratio is obtained at a pixel area. In addition, when a fully-depleted channel layer, which has a thin semiconductor layer, is used, since only a few pairs of electrons and positive holes are generated due to light in the semiconductor layer, optical leak is prevented and the display quality of the electro-optical apparatus is improved. Further, in the peripheral circuits, when fully-depleted transistors, which have small parasitic capacitance, are used in a circuit requiring a speed, such as a shift register, and partially-depleted transistors are used in a circuit requiring a current driving capability, such as a buffer, most appropriate transistors required by the peripheral circuits are disposed.

In electro-optical apparatuses according to the present invention, it is preferred that the semiconductor layer be made from monocrystalline silicon. According to such a structure, a driving frequency is increased by the use of monocrystalline silicon, and a high-quality, high-definition liquid-crystal apparatus is obtained.

In electro-optical apparatuses according to the present invention, it is preferred that the semiconductor layer be made from polycrystalline silicon. According to such a structure of the present invention, by using polycrystalline silicon, a high-definition liquid-indication apparatus is obtained at low cost.

In electro-optical apparatuses according to the present invention, it is preferred that the supporting substrate be a transparent substrate. According to the structure of the present invention, since a transparent substrate is used, a transmissive liquid-crystal apparatus can be made.

In electro-optical apparatuses according to the present invention, it is preferred that the supporting substrate be a quartz substrate. According to the structure of the present invention, since a quartz substrate is used, a high-temperature process having a temperature of up to 1,150 degrees Celsius can be applied to TFT production. Consequently, high-performance TFTs are obtained.

In electro-optical apparatuses according to the present invention, it is preferred that the supporting substrate be a glass substrate. According to the structure of the present invention, since a glass substrate is used, a large-area substrate can be used and a liquid-crystal apparatus can be made at low cost.

In electro-optical apparatuses according to the present invention, it is preferred that a light-shielding layer be further provided between the supporting substrate and the semiconductor layer. According to the structure of the present invention, direct incident light from the rear surface of the substrate is suppressed and a generation of optical leak caused when light reflected by the rear surface of the substrate enters a transistor-device-forming area is also suppressed. In addition, the deterioration of a characteristic for writing a signal into a pixel is prevented.

In electro-optical apparatuses according to the present invention, it is preferred that the film thickness of the fully-depleted channel layer fall in the range from 30 nm to 100 nm. According to the structure of the present invention, since the film thickness of the channel layer is 100 nm or less, even when the channel has a high impurity concentration, since the channel layer becomes thinner than the expansion of a depleted layer, a fully-depleted transistor is obtained. Since the film thickness of the channel layer is 30 nm or more, the dispersion of the threshold voltage and others of the transistor can be made small. In addition, in the channel layer having such a film thickness, since a low optical leakage current flows due to pairs of electrons and positive holes caused by optical pumping, a high-display-quality electro-optical apparatus is obtained.

Further, an electro-optical apparatus according to the present invention is characterized by further comprising, opposite the surface on which the semiconductor layer is formed in the substrate acting as another substrate, one substrate; and liquid crystal driven by the transistors formed in the semiconductor layer and sandwiched by the one substrate and the other substrate.

An electronic unit according to the present invention is characterized by comprising a light source; the electro-optical apparatus to which light emitted from the light source is incident and in which modulation corresponding to image information is applied; and projection means for projecting the light modulated by the electro-optical apparatus.

### BRIEF DESCRIPTION OF THE DRAWINGS

FIG. 1 shows an equivalent circuit showing the structure of an image forming area in a liquid-crystal apparatus according to an embodiment of the present invention.

FIG. 2 is a plan showing the structure of a group of a plurality of adjacent pixels in a TFT array substrate in the liquid-crystal apparatus.

FIG. 3 is a sectional view obtained along A-A′ of FIG. 2.

FIG. 4 is a plan showing the structure of the liquid-crystal apparatus according to the embodiment of the present invention.

FIG. 5 is a sectional view obtained along H-H′ of FIG. 4.

FIG. 6 is a circuit diagram showing an example structure of scanning-line driving in the liquid-crystal apparatus according to the embodiment of the present invention.

FIG. 7 is a plan showing the structure of a projection-type display apparatus serving as an example electronic unit using the liquid-crystal apparatus.

FIG. 8 is a plan showing an inverter circuit serving as an example peripheral driving circuit in the TFT array substrate of the liquid-crystal apparatus.

FIG. 9 is a sectional view obtained along X-X′ of FIG. 8.

### BEST MODE FOR CARRYING OUT THE INVENTION

Embodiments of the present invention will be described below by referring to the drawings.

(Structure of electro-optical apparatus)

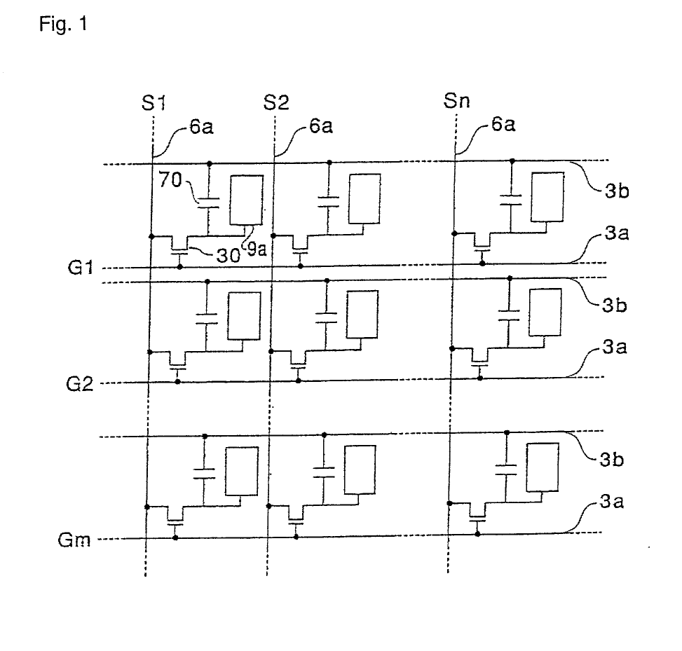

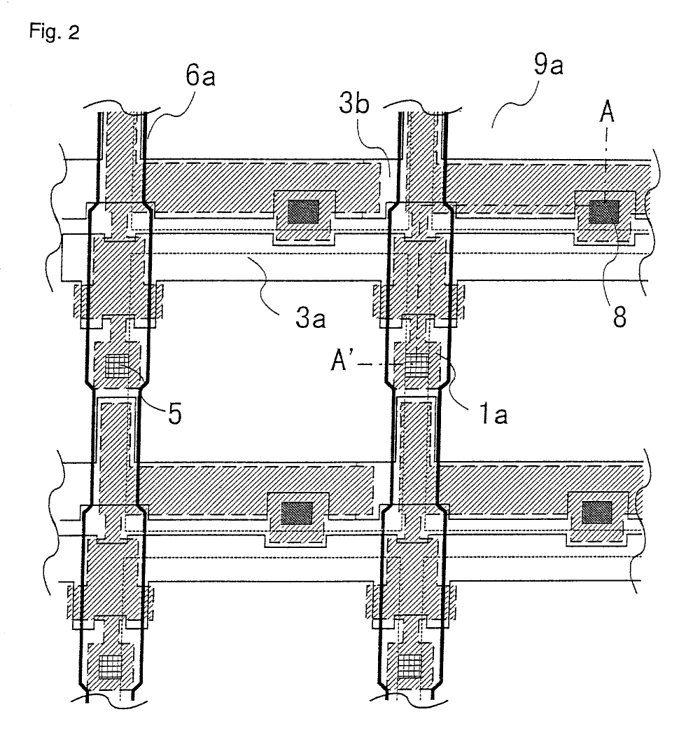

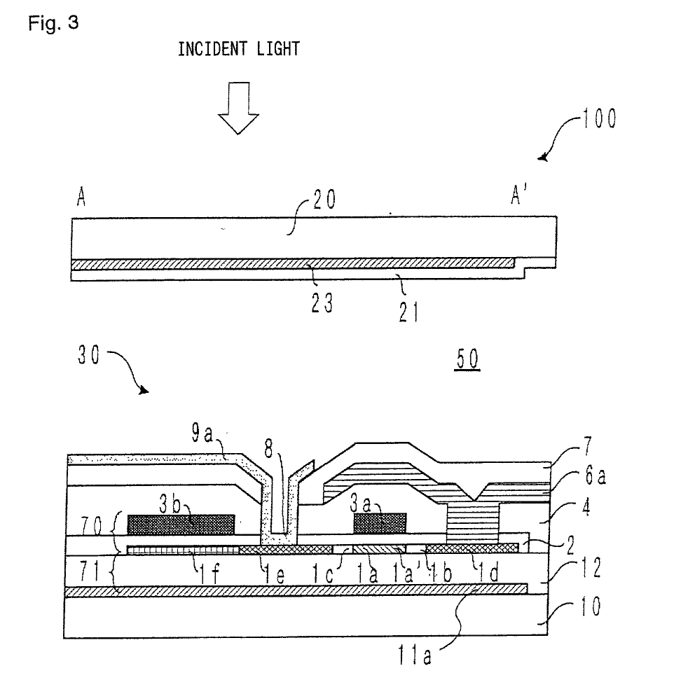

FIG. 1 is a view showing an equivalent circuit of an image forming area in a liquid-crystal apparatus serving as an electro-optical apparatus according to an embodiment of the present invention. FIG. 2 is a plan of a group of a plurality of adjacent pixels in a TFT array substrate in which data lines, scanning lines, pixel electrodes, and light-shielding films are formed. FIG. 3 is a sectional view obtained along line A-A′ of FIG. 2. In FIG. 2 and FIG. 3, to magnify each layer and each member so that they are recognizable, a different scale is applied to each layer or each member. In FIG. 2, the X direction indicates the direction parallel to a direction in which the scanning lines are formed, and the Y direction indicates the direction parallel to a direction in which the data lines are formed.

In FIG. 1, a plurality of pixels constituting an image display area in the liquid-crystal apparatus according to the present embodiment includes a plurality of pixel electrodes 9a formed in a matrix manner, and TFTs 30 serving as transistors for controlling the pixel electrodes 9a. Data lines 6a through which image signals are sent are electrically connected to the sources of the TFTs 30. The image signals S1, S2, . . . , and Sn written into the data lines 6a may be sent in that order in a line sequential manner. Alternatively, the image signals may be sent to a plurality of adjacent data lines 6a in units of groups.

Scanning lines 3a are electrically connected to the gates of the TFTs 30. Scanning signals G1, G2, . . . , and Gm are applied in a pulsed manner to the scanning lines 3a in that order in a line sequential manner at predetermined timing. The pixel electrodes 9a are electrically connected to the drains of the TFTs 30. The TFTs 30, serving as switching devices, are closed for a certain period to write the image signals S1, S2, . . . , and Sn sent through the data lines 6a at predetermined timing. The image signals S1, S2, . . . , and Sn having predetermined levels, written into liquid crystal through the pixel electrodes 9a, are held for a certain period between the pixel electrodes 9a and an opposed electrode (described later) formed on an opposed substrate (described later).

The liquid crystal modulates light and allows gray-scale display because the alignment and the order of its sets of molecules change according to the levels of applied voltages. In a normally white mode, incident light is blocked by the liquid-crystal portion in relation to an applied voltage. In a normally black mode, incident light passes through the liquid-crystal portion in relation to an applied voltage. As a whole, the liquid-crystal apparatus outputs light having a contrast corresponding to image signals. To prevent held image signals from leaking, accumulating capacitors 70 are added in parallel to liquid-crystal capacitors formed between the pixel electrodes 9a and the opposed electrode. With this capacitor, a holding characteristic is further improved to implement a high-contrast liquid-crystal apparatus. In the present embodiment, to form such accumulating capacitors 70, capacitor lines 3b are especially formed in the same layer as the scanning lines, as described later, or with a low resistance by using an electrically conductive light-shielding film.

FIG. 2 is a plan showing the structure of a group of a plurality of adjacent pixels in the TFT array substrate in which data lines, scanning lines, pixel electrodes, and light-shielding films are formed. In FIG. 2, the plurality of transparent pixel electrodes 9a (their outlines are indicated by dotted lines) are formed in a matrix manner on the TFT array substrate in the liquid-crystal apparatus. Along the horizontal and vertical boundaries of the pixel electrodes 9a, the data lines 6a, the scanning lines 3a, and the capacitor lines 3b are formed. The data lines 6a are electrically connected to source regions, described later, of a semiconductor layer 1a formed of a monocrystalline silicon layer, through contact holes 5. The pixel electrodes 9a are electrically connected to drain regions of the semiconductor layer 1a through contact holes 8. In the semiconductor layer 1a, the scanning lines 3a are disposed opposite to channel regions and serve as gate electrodes.

The capacitor lines 3b have main sections (namely, first areas formed along the scanning lines 3a at a top view) extending almost in a straight-line manner along the scanning lines 3a and a protrusion section (namely, second areas extending along the data lines 6a at a top view) protruding toward the previous-stage sides (upper direction in the figure) along the data lines 6a from portions where the capacitor lines 3b intersect the data lines 6a.

Under the area where the semiconductor layer 1a shown in FIG. 2 is formed, although not shown in the figure, a plurality of first light-shielding films (first light-shielding films 11a shown in FIG. 3) are formed. More specifically, the first light-shielding films are formed in pixel sections so as to cover the TFTs, which include the channel regions of the semiconductor layer 1a, when viewed from the TFT-array-substrate side, and have main sections extending in a straight-line manner along the scanning lines 3a opposite to the main sections of the capacitor lines 3b and protrusion sections protruding toward adjacent-stage sides (namely, lower direction in the figure) along the data lines 6a from areas where the data lines 6a intersect. The tips of the protrusion sections directed in the lower direction in each stage (each pixel row) of the first light-shielding films overlap with the tips of the protrusion sections of the capacitor lines 3b directed in the upper direction in the next stages under the data lines 6a.

As shown in the sectional view of FIG. 3, the liquid-crystal apparatus includes a TFT array substrate 10 serving as an optically-transparent substrate and a transparent opposed substrate 20 disposed opposite to the TFT array substrate 10. The TFT array substrate 10 is made, for example, from a quartz substrate, and the opposed substrate 20 is made, for example, from a glass substrate or a quartz substrate. The TFT array substrate 10 is provided with the pixel electrodes 9a, and alignment films (not shown in the figure) to which predetermined alignment processing has been applied, such as rubbing processing, are also formed thereabove. The pixel electrodes 9a are formed, for example, of a transparent electrically conductive thin film, such as an ITO film (indium tin oxide film). The alignment films 16 are formed, for example, of an organic thin film such as a polyimide thin film.

The opposed substrate 20 is provided with an opposed electrode (common electrode) 21 over the entire surface thereof. Alignment films (not shown in the figure) to which predetermined alignment processing has been applied, such as rubbing processing, is also formed therebelow. The opposed electrode 21 is made, for example, from a transparent electrically conductive thin film such as an ITO film. The alignment films are formed of an organic thin film such as a polyimide thin film.

As shown in FIG. 3, the pixel-switching TFT 30 for controlling the switching of each pixel electrode 9a is formed at a position close to the pixel electrode 9a in the TFT array substrate 10.

The opposed substrate 20 is further provided with a second light-shielding film 23 at areas other than the opening area of each pixel section. Therefore, incident light coming from the opposed substrate 20 side does not enter channel regions 1a, or LDD (lightly doped drain) regions 1b and 1c of the semiconductor layer 1a in the pixel-switching TFT 30. In addition, the second light-shielding film 23 has functions for improving a contrast and for preventing the mixture of color members.

Between the TFT array substrate 10 and the opposed substrate 20 structured in this way and disposed such that the pixel electrodes 9a and the opposed electrode 21 face each other, liquid crystal is sealed in a space surrounded by a sealing member (not shown in the figure) to form a liquid-crystal layer 50. The liquid-crystal layer 50 maintains a predetermined alignment state due to the alignment films 16 and the alignment film disposed at the opposed substrate 20 in a condition in which an electric field is not applied from the pixel electrodes 9a. The liquid-crystal layer 50 has liquid crystal obtained by mixing, for example, one type or several types of nematic liquid crystal. The sealing member is an adhesive made, for example, from a light-curing resin or a thermosetting resin, and is used around the substrates for adhering the TFT array substrate 10 and the opposed substrate 20. In the sealing member, spacers, such as glass fiber or glass beads, used for keeping the distance between both substrates at a predetermined value are mixed.

As shown in FIG. 3, at each position opposite to the pixel-switching TFT 30, each first light-shielding film 11a is provided on the surface of the TFT array substrate 10 at a position corresponding to each pixel-switching TFT 30. The first light-shielding film 11a is preferably formed of a single metal, an alloy, or a metal silicide which includes at least one of Ti, Cr, W, Ta, Mo, and Pb, which are nontransparent metals having high melting points. When the first light-shielding film 11a is formed of such a material, the first light-shielding film 11a is prevented from being destroyed and from melting in a high-temperature process used in a process for forming the pixel-switching TFTs 30, which is performed after a process for forming the first light-shielding films 11a disposed on the TFT array substrate 10. Since the first light-shielding film 11a is formed, light returning from the TFT array substrate 10 side is prevented from entering the channel regions 1a, and the LDD regions 1b and 1c in the pixel-switching TFTs 30. The characteristics of the pixel-switching TFTs 30 serving as transistor devices do not deteriorate due to the occurrence of a photocurrent.

Between the first light-shielding film 11a and a plurality of pixel-switching TFTs 30, a first inter-layer insulating film 12 is also provided. The first inter-layer insulating film 12 is formed in order to electrically insulate the semiconductor layer 1a constituting the pixel-switching TFTs 30 from the first light-shielding film 11a. Since the first inter-layer insulating film 12 is formed over the entire surface of the TFT array substrate 10, it also has a function for serving as a ground film for the pixel-switching TFTs 30. In other words, the first inter-layer insulating film 12 has a function for preventing the characteristics of the pixel-switching TFTs 30 from deteriorating if the TFT array substrate 10 has a rough surface due to polishing or if it has a stain remaining after cleaning. The first inter-layer insulating film 12 is formed of a highly-insulating glass, such as NSG (non-doped silicate glass), PSG (phosphorus silicate glass), BSG (boron silicate glass), and BPSG (boron phosphorus silicate glass), a silicon oxide film, or a silicon nitride film. The first inter-layer insulating film 12 can also prevent the first light-shielding film 11a from contaminating the pixel-switching TFTs 30.

In the present embodiment, a gate insulating film 2 is extended from a position opposite that of the scanning lines 3a and serves as a dielectric film, the semiconductor layer 1a is extended and serves as a first accumulating-capacitor electrode if, and a part of the capacitor lines 3b opposite to the dielectric film and the first accumulating-capacitor electrode if serves as a second accumulating-capacitor electrode to form an accumulating capacitor 70. More specifically, a high-concentration drain region 1e of the semiconductor layer 1a is disposed opposite parts of the capacitor lines 3b extending along the data lines 6a and the scanning lines 3a, through the insulating film 2, and serves as the first accumulating-capacitor electrode (semiconductor layer) if. Especially, since the insulating film 2 serving as a dielectric member of the accumulating capacitor 70 is exactly the gate insulating film 2 of the TFT 30 formed by high-temperature oxidation on the silicon layer, it can be a thin insulating film having a high dielectric strength. Therefore, the accumulating capacitor 70 can be a large-capacitance accumulating capacitor having a relatively small area.

In addition, as understood from FIG. 3, the first light-shielding film 11a is disposed opposite the first accumulating-capacitor electrode 1f through the first inter-layer insulating film 12 as a third accumulating-capacitor electrode, at the opposite side of the capacitor lines 3b, which serve as the second accumulating-capacitor electrode. When the first light-shielding film 11a is always set to a constant potential, such as a power potential or the same potential as the capacitor lines 3b, although this condition is not shown in the figure, an accumulating capacitor 71 is further given. In other words, in the present embodiment, a double-accumulating-capacitor structure is formed in which accumulating capacitors are given at both sides of the first accumulating-capacitor electrode 1f, and thereby, the accumulating capacitance is increased. Therefore, a function of the liquid-crystal apparatus for preventing flickers in displayed images and image sticking is enhanced.

As a result, the areas below the data lines 6a and areas (namely, where the capacitor lines 3b are formed) where the disclination of the liquid crystal occurs along the scanning lines 3a, which are areas other than aperture areas, are effectively used to increase the accumulating capacitance of the pixel electrode 9a.

Since the first light-shielding films 11a (and the capacitor lines 3b electrically connected thereto) are electrically connected to a constant potential source (not shown in the figure) outside the pixel areas, the first light-shielding films 11a and the capacitor lines 3b have a constant potential. Therefore, potential fluctuation of the first light-shielding films 11a does not adversely affect the pixel-switching TFTs 30, which are disposed opposite the first light-shielding films 11a . The capacitor lines 3b successfully function as the second accumulating-capacitor electrodes of the accumulating capacitors 70.

In this case, as the constant potential source, a constant potential source for supplying a negative voltage or a positive voltage to peripheral circuits (such as a scanning-line driving circuit and a data-line driving circuit) which drive the liquid-crystal apparatus, a ground power supply, or a constant potential source for supplying power to the opposed electrode 21 can be used. With a power supply such as that for the peripheral circuits being used, the light-shielding films 11a and the capacitor lines 3b are always set to a constant potential without providing a special potential wire or an external input terminal.

In FIG. 3, the pixel-switching TFT 30 is a fully-depleted p-type transistor. The film thickness of the semiconductor layer 1a is set to a constant value between 30 nm and 100 nm, preferably, between 40 nm and 60 nm. When the semiconductor layer 1a has a film thickness of 100 nm or less, since a depletion layer controlled by a gate electrode is extended larger than the semiconductor layer 1a irrespective of the concentration of impurities in the channel section, the pixel-switching TFT 30 becomes a fully-depleted transistor. The pixel-switching TFT 30 has a LDD (lightly doped drain) structure, and includes a scanning line 3a, the channel region 1a′ where a channel is formed by the electric field generated by the scanning line 3a in the semiconductor layer 1a, the gate insulating film 2 for insulating the scanning line 3a from the semiconductor layer 1a, a data line 6a, the low-concentration source region (LDD region at the source side) 1b and the low-concentration drain region (LDD region at the drain side) 1c of the semiconductor layer 1a, and the high-concentration source region 1d and the high-concentration drain region 1e of the semiconductor layer 1a.

Among them, the high-concentration drain region 1e is connected to the corresponding one of the plurality of pixel electrodes 9a. The source regions 1b and 1d and the drain regions 1c and 1e are formed, as described later, by doping the semiconductor layer 1a with p-type impurity ions at a predetermined concentration. Since a parasitic bipolar effect is unlikely to occur in a p-type transistor having the above structure, it is not necessary to always set the potential of the channel section constant. Therefore, when such a transistor is used as a pixel-switching TFT 30, a high aperture ratio is obtained.

In addition, since the semiconductor layer 1a is 30 nm thick or more, and preferably, 40 nm thick or more, the dispersion of transistor characteristics, such as a threshold voltage, determined by the film thickness of the channel regions 1a, is made small. Further, since the semiconductor layer 1a is 100 nm thick or less, and preferably, 60 nm thick or less, even if stray light which cannot be blocked by the first light-shielding film 11a is incident on the semiconductor layer 1a, the amount of generated pairs of electrons and positive holes in optical pumping is suppressed to a low level. Therefore, an optical leakage current is made low and such a transistor is effectively used as a pixel-switching TFT 30 serving as a pixel switching device. The data lines 6a are formed of a light-shielding metallic thin film such as a metal film, including Al, and an alloy film, including metal silicide. On the scanning lines 3a, the gate insulating films 2, and the first inter-layer insulating film 12, a second inter-layer insulating film 4 in which contact holes 5 passing to the high-concentration source regions 1d and contact holes 8 passing to the high-concentration drain regions 1e are formed is generated. Through the contact holes 5 passing to the source regions 1b, the data lines 6a are electrically connected to the high-concentration source regions 1d. On the data lines 6a and the second inter-layer insulating film 4, a third inter-layer insulating film 7 in which contact holes 8 passing to the high-concentration drain regions 1e are formed is generated. Through the contact holes 8 passing to the high-concentration drain regions 1e, the pixel electrodes 9a are electrically connected to the high-concentration drain regions 1e. The pixel electrodes 9a, described before, are formed on the third inter-layer insulating film 7 structured in this way. The pixel electrodes 9a and the high-concentration drain regions 1e may be electrically connected through the same Al film as the data lines 6a or the same poly-silicon film as the scanning lines 3b.

The pixel-switching TFTs 30 preferably have the LDD structure as described above. The pixel-switching TFTs 30 may have an offset structure in which impurity-ion implantation is not performed in the low-concentration source regions 1b and the low-concentration drain regions 1c. The pixel-switching TFTs 30 may be self-alignment TFTs in which impurity-ions are implanted at a high concentration with the gate electrodes 3a being used as a mask to form high-concentration source regions and high-concentration drain regions in a self-alignment manner.

The pixel-switching TFTs 30 have a single-gate structure in which only one gate electrode (scanning line) 3a is disposed between a source region 1b and a drain region 1e. Two or more gate electrodes may be disposed therebetween. In this case, an identical signal is applied to each gate electrode. When a TFT is formed with double gates, triple gates, or more, a leakage current is prevented at junction sections between the channel, and the source and drain regions, and a current flowing when a transistor is off is reduced. When at least one of these gate electrodes has the LDD structure or the offset structure, the off current is further reduced to obtain a stable switching device.

In general, in monocrystalline silicon layers, such as the channel regions 1a′, the low-concentration source regions 1b, and the low-concentration drain regions 1c in the semiconductor layer 1a, when light is incident, a photocurrent is generated due to the photoelectric conversion effect of silicon, and the transistor characteristics of the pixel-switching TFTs 30 deteriorate. In the present embodiment, since the data lines 6a are formed of a light-shielding metal thin film, such as Al, so as to cover the scanning lines 3a from the above, light is effectively prevented from being incident at least on the channel regions 1a′ and the LDD regions 1b and 1c in the semiconductor layer 1a. In addition, as described above, since the first light-shielding films 11a are formed below the pixel-switching TFTs 30, returning light is also effectively prevented from being incident at least on the channel regions 1a′, the low-concentration source regions 1b, and the low-concentration drain regions 1c in the semiconductor layer 1a. Furthermore, even if light leaking from the above structure is incident, since the semiconductor layer 1a of the pixel-switching TFTs 30 is thin, optical leakage is sufficiently suppressed.

The above embodiment is not limited to a case in which the semiconductor layer 1a is formed of monocrystalline silicon. The same structure can also be applied to a case in which the semiconductor layer 1a is formed of polycrystalline silicon. A semiconductor other than silicon may also be used.

(Overall structure of liquid-crystal apparatus)

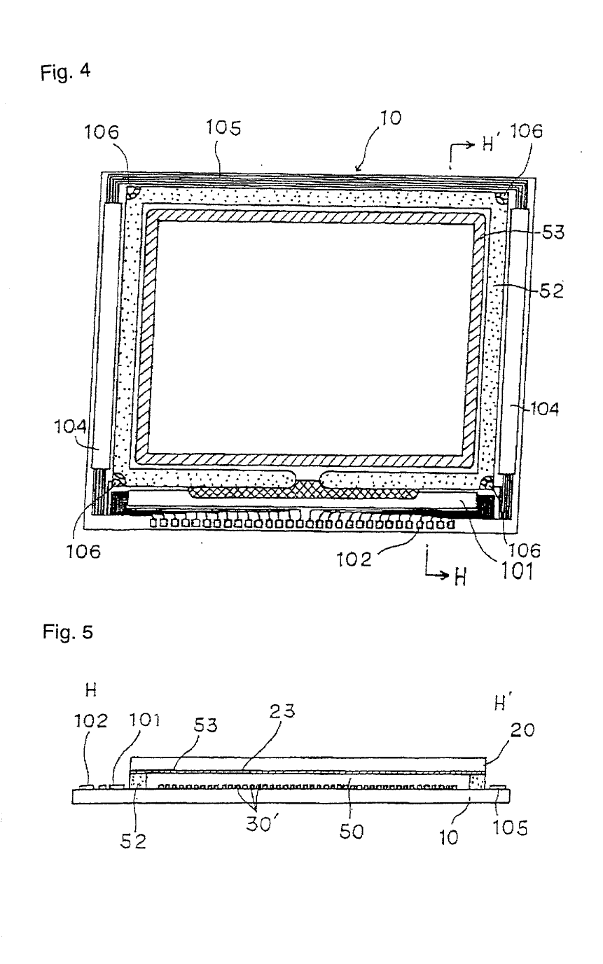

The whole structure of the liquid-crystal apparatus according to the present embodiment will be described below by referring to FIG. 4 and FIG. 5. FIG. 4 is a plan of the TFT array substrate 10 when viewed from the opposed substrate 20 side together with each component formed in the TFT array substrate 10. FIG. 5 is a sectional view obtained along H-H′ of FIG. 4, also showing the opposed substrate 20.

As shown in FIG. 4, the opposed substrate 20 is provided with a third light-shielding film 53 serving as a frame, made from the same or a different material as the second light-shielding film 23, parallel to and inside a sealing member 52.

The TFT array substrate 10 is provided at areas outside the sealing member 52 with a data-line driving circuit 101 and external-circuit connection terminals 102 along one side of the TFT array substrate 10, and with scanning-line driving circuits 104 along two sides adjacent to the side described above. If delays of scanning signals sent to the scanning lines 3a cause no problem, only one scanning-line driving circuit 104 may be disposed at one side. The data-line driving circuit 101 may be disposed at each of both sides of a screen display area. It may be configured, for example, that a data-line driving circuit disposed along one side of the image display area sends image signals to data lines 6a of odd-numbered rows, and a data-line driving circuit disposed along the other side of the image display area sends image signals to data lines of even-numbered rows. When the data lines 6a are driven in a comb-tooth manner in this way, since the area occupied by the data-line driving circuits is increased, complicated circuits can be formed. Along the remaining side of the TFT array substrate 10, a plurality of wires 105 for connecting the scanning-line driving circuits 104 disposed at both sides of the image display area are provided. At least at one of the corners of the opposed substrate 20, a conductive member 106 for electrically connecting the TFT array substrate 10 and the opposed substrate 20 is formed. As shown in FIG. 5, the opposed substrate 20, which has almost the same outline as the sealing member 52, is secured to the TFT array substrate 10 by the sealing member 52.

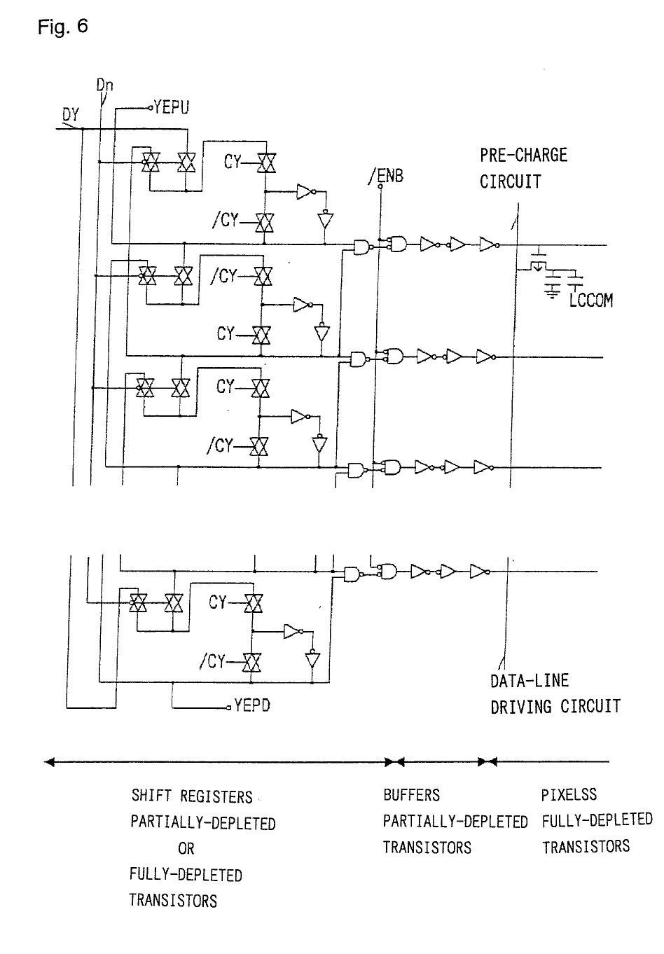

FIG. 6 shows an example circuit diagram of the scanning-line driving circuits 104. The scanning-line driving circuits 104 are formed of shift registers and buffers. Since the scanning-line driving circuits 104 are disposed at positions where light is completely blocked in the substrate and therefore there is no need to take an optical leakage current into consideration, all the circuits may be formed of partially-depleted transistors, which have a thick semiconductor layer.

To increase the driving frequency, it is necessary to drive the shift registers at a high speed. In this case, fully-depleted transistors, which allow parasitic capacitance to be made small, are appropriate. Since the buffers need to have a high-current-driving capability to drive the scanning lines, partially-depleted transistors are appropriate. As described above, the whole of the peripheral circuits may be formed of partially-depleted transistors. Alternatively, partially-depleted transistors and fully-depleted transistors may be used depending on each circuit. It is possible in some cases that a circuit such as a transmission gate is formed of only one-type of transistors. In this case, if p-type transistors are used, a body contact is not required and a layout advantage is obtained.

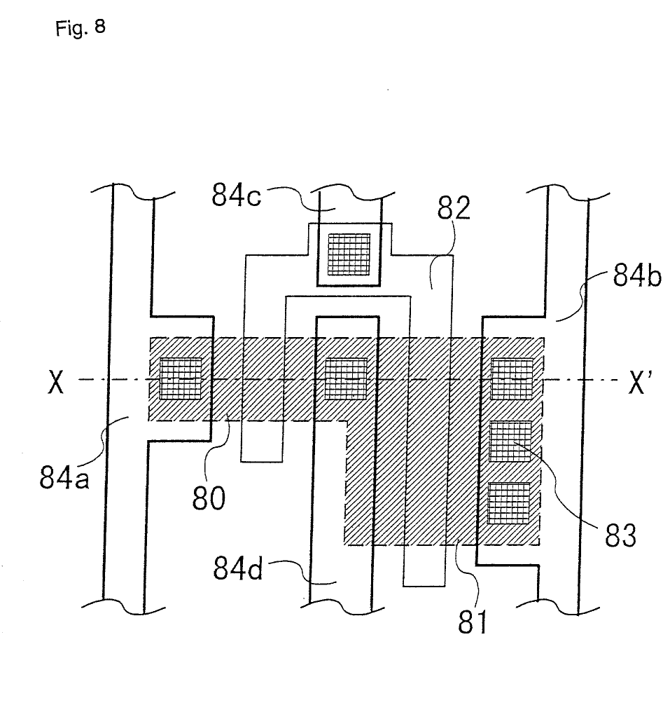

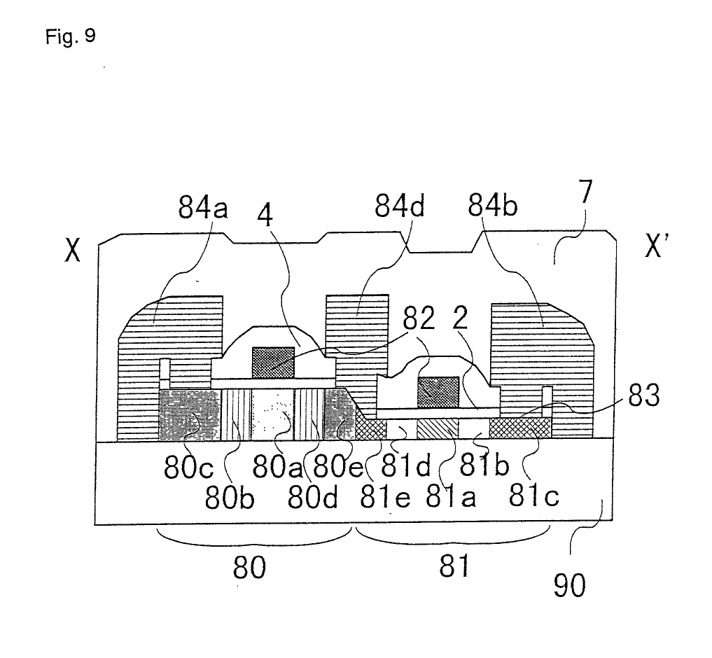

The structure of an inverter circuit, which is an example of the peripheral circuits, will be described next by referring to FIG. 8 and FIG. 9. FIG. 8 is a plan layout view of the inverter, and FIG. 9 is a sectional view obtained along X-X′ of FIG. 8. In FIG. 8 and FIG. 9, there are shown an n-type transistor 80, a p-type transistor 81, a gate 82, contact holes 83, a ground potential line 84a, a power potential line 84b, an input signal line 84c, and an output signal line 84d. In FIG. 9, there are also shown a channel region 80a of the n-type transistor, a low-concentration source region 80b of the n-type transistor, a high-concentration source region 80c of the n-type transistor, a low-concentration drain region 80d of the n-type transistor, a high-concentration drain region 80e of the n-type transistor, a channel region 81a of the p-type transistor, a low-concentration source region 81b of the p-type transistor, a high-concentration source region 81c of the p-type transistor, a low-concentration drain region 81d of the p-type transistor, and a high-concentration drain region 81e of the p-type transistor. In FIG. 8 and FIG. 9, the n-type and the p-type transistors have a structure in which low-concentration LDD regions are disposed at both sides of the channels. Such regions may be not formed. Alternatively, only the low-concentration regions 80d and 81d at the drain sides may be formed. Of course, only one of the n-type and p-type transistors may have the above structure. In FIG. 8 and FIG. 9, a structure is illustrated in which the high-concentration drain region 80e of the n-type transistor contacts the high-concentration drain region 81e of the p-type transistor. These two regions may be electrically separated. Although not shown in FIG. 8 or FIG. 9, a so-called source tie structure may be formed, in which p-type impurities are implanted into the both-end section (an upper-end section and a lower-end section in the horizontal direction in FIG. 8) of the drain regions 80b and 80c of the n-type transistor 80. In the same way, the p-type transistor 81 may have a source tie structure. Furthermore, although not shown in FIG. 8 or FIG. 9, the first light-shielding film 11a shown in FIG. 3 may be formed below the transistors 80 and 81. Since the transistors disposed in the pixel sections are fully-depleted p-type transistors, as described before, a fully-depleted type is also used for the p-type transistor 81 in this peripheral circuit. The n-type transistor 80 in this peripheral circuit is a partially-depleted type, as shown in FIG. 9. With the above structure, since required transistors are one kind of p-type transistors and one kind of n-type transistors, the number of processes required for producing the required transistors is set as low as possible.

In the foregoing description, the inverter circuit has been taken as an example. Other CMOS logic circuits can be formed of fully-depleted p-type transistors and partially-depleted n-type transistors. Circuits such as a transmission gate can be, in some cases, formed of only one-type of transistors. In this case, if fully-depleted p-type transistors are used, a body contact is not required and a layout advantage is obtained.

The film thickness of the semiconductor layer in the fully-depleted transistors having the above structure is set to the same as that of the TFT 30 constituting a pixel, which has a constant value between 30 nm and 100 nm, preferably, between 40 nm and 60 nm. With this setting, an additional process is not required. The film thickness of the semiconductor layer in the partially-depleted transistors is set to a constant value equal to 100 nm or more, preferably equal to 150 nm or more. In transistors for the peripheral circuits, a body contact may be provided, which fixes the potential of the channel section to obtain an appropriate breakdown voltage. A body contact may be not provided for high integration.

In addition, an inspection circuit or others for checking the quality and defects of the liquid-crystal apparatus during manufacturing or at shipment time may be formed on the TFT array substrate 10. A polarizing film, a retardation film, polarizing means, and others are disposed in predetermined directions at each of a side where incoming light is incident on the opposed substrate 20 and a side where outgoing light exits the TFT array substrate 10, according to an operation mode, such as TN (twisted nematic) mode, STN (super-TN) mode, and D-STN (dual-scan-STN) mode, and whether the mode is the normally white mode or the normally black mode.

When the liquid-crystal apparatus described above is used, for example, for a color liquid-crystal projector (projection-type display apparatus), three of the liquid-crystal apparatuses serve as R, G, and B light valves. In this case, light is separated by an RGB-separating dichroic mirror and is incident on each panel, and then, combined for projection. Therefore, in this case, unlike the present embodiment, the opposed substrate 20 cannot be provided with a color filter.

When the liquid-crystal apparatus according to the present embodiment is used as a color liquid-crystal apparatus other than liquid-crystal projectors, such as a direct-view or a reflection-type color liquid-crystal TV set, it is only required that a RGB color filter and its protection film be formed on the opposed substrate 20 at predetermined areas opposite the pixel electrodes 9a where the second light-shielding film 23 is not formed.

When the liquid-crystal apparatus according to the present embodiment is used as a light valve of a liquid-crystal projector, one micro-lens may be formed per pixel on the opposed substrate 20. In this case, light-collecting efficiency is improved for incident light to implement a bright liquid-crystal apparatus. Furthermore, several interference layers having different refractive indexes may be deposited on the opposed substrate 20 to form a dichroic filter, which generates R, G, and B colors by the use of interference of light. With this opposed substrate having the dichroic filter, a brighter, color liquid-crystal apparatus is implemented.

In the liquid-crystal apparatus according to the present embodiment described above, light is incident from the opposed substrate 20 side. Since the first light-shielding films 11a are provided, the apparatus may be configured such that light is incident from the TFT array substrate 10 side and output from the opposed substrate 20 side. Even when the liquid-crystal apparatus is used as a light valve of a liquid-crystal projector, since the channel regions 1a′, the low-concentration source regions 1b, and the low-concentration drain regions 1c of the semiconductor layer 1a prevent light from being incident, high-quality images can be displayed. Although it is conventionally necessary to separately dispose polarizing means covered with a reflection-preventing AR (anti-reflection) film or to adhere an AR film in order to prevent light from reflecting from the rear surface of the TFT array substrate 10, since the first light-shielding films 11a are formed between the front surface of the TFT array substrate 10 and the channel regions 1a′, the low-concentration source regions 1b, and the low-concentration drain regions 1c of the semiconductor layer 1a in the present embodiment, it is not necessary to use such an AR-film-coated polarizing means or such an AR film, and it is not necessary to use the TFT array substrate 10 to which AR processing is applied. Therefore, each embodiment provides superior advantages in that material cost is reduced, and a reduction in yield due to attached dust or a scratch is prevented when polarizing means is attached. In addition, with a high light-proof capability, even if a bright light source is used or polarizing-light conversion is performed by a polarizing beam splitter to improve the light-use efficiency, image deterioration such as cross-talk due to light does not occur.

(Electronic unit)

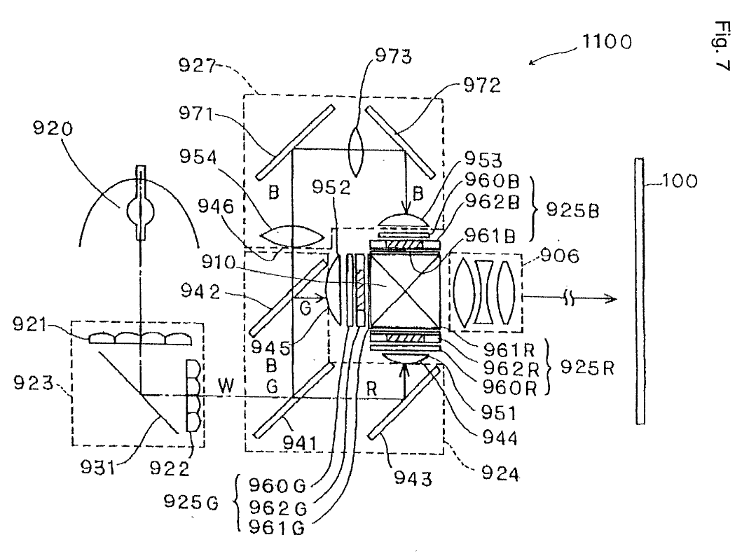

The structure of a projection-type display apparatus will be described next as an example electronic unit using the above liquid-crystal apparatus, by referring to FIG. 7. FIG. 7 is a view showing a rough structure of an optical system in a projection-type liquid-crystal apparatus 1100 which uses three of the above liquid-crystal apparatuses as RGB liquid-crystal apparatuses 962R, 962G, and 962B. The optical system of the projection-type display apparatus 1100 of the present embodiment employs a light source apparatus 920 and a uniform-illumination optical system 923. The projection-type display apparatus 1100 includes a color-separating optical system 924 for dividing an optical flux W output from the uniform-illumination optical system 923 into red (R), green (G), and blue (B) light, light valves 925R, 925G, and 925B for modulating R, G, and B color optical fluxes, a color combining prism 910 for re-combining the modulated color optical fluxes, and a projection lens unit 906 serving as projection means for magnifying and projecting the combined optical flux on the surface of a projection plane 100. In addition, a light-guide system for guiding the blue optical flux B to the corresponding light valve 925B is also provided.

The uniform-illumination optical system 923 has two lens plates 921 and 922, and a reflecting mirror 931. The two lens plates 921 and 922 are disposed with the reflecting mirror 931 being sandwiched therebetween so as to be perpendicular to each other. The two lens plates 921 and 922 of the uniform-illumination optical system 923 each have a plurality of rectangular lenses disposed in a matrix manner. An optical flux output from the light source apparatus 920 is divided into a plurality of partial optical fluxes by the rectangular lenses of the first lens plate 921. These partial optical fluxes are superposed near the three light valves 925R, 925G, and 925B by the rectangular lenses of the second lens plate 922. Therefore, with the use of the uniform-illumination optical system 923, even if the light source apparatus 920 has a non-uniform illuminance distribution in a cross section of the output optical flux, the three light valves 925R, 925G, and 925B are illuminated with uniform illumination light.

The color-separating optical system 924 is formed of a blue-and-green-reflecting dichroic mirror 941, a green-reflecting dichroic mirror 942, and a reflecting mirror 943. The blue-and-green-reflecting dichroic mirror 941 reflects the blue optical flux B and the green optical flux G included in the optical flux W perpendicularly toward the green-reflecting dichroic mirror 942. The red optical flux R passes through the blue-and-green-reflecting dichroic mirror 941, is reflected by the reflecting mirror 943 disposed thereafter, and is output from an outgoing section 944 for the red optical flux R toward the color combining optical system.

Of the blue optical flux B and the green optical flux G reflected by the blue-and-green-reflecting dichroic mirror 941, only the green optical flux G is perpendicularly reflected by the green-reflecting dichroic mirror 942 and is output from an outgoing section 945 for the green optical flux G toward the color combining optical system. The blue optical flux B passing through the green-reflecting dichroic mirror 942 is output from an outgoing section 945 for the blue optical flux B toward the light-guide system 927. In the present embodiment, the distance between an outgoing section for the optical flux W in the uniform-illumination optical device to each of the outgoing sections 944, 945, and 946 for the color optical fluxes in the color-separating optical system 924 is set almost equal.

Condenser lenses 951 and 952 are disposed at the outgoing side of the outgoing section 944 for the red optical flux R and at the outgoing side of the outgoing section 945 for the green optical flux G in the color-separating optical system 924, respectively. Therefore, the red optical flux R and the green optical flux G output from the outgoing sections are incident on the condenser lenses 951 and 952, respectively, to be made parallel.

The red optical flux R and the green optical flux G made parallel in this way are incident on the light valves 925R and 925G, and are modulated, thus adding corresponding image information to the fluxes. In other words, these liquid-crystal apparatuses are switched and controlled by driving means (not shown) according to image information to modulate light of each color passing therethrough.

The blue optical flux B is guided to the corresponding light valve 925B through the light-guide system 927, and is modulated according to the image information in the same way. The light valves 925R, 925G, and 925B according to the present embodiment respectively have incoming-side polarizing means 960R, 960G, and 960B, outgoing-side polarizing means 961R, 961G, and 961B, and the liquid-crystal apparatuses 962R, 962G, and 962B disposed therebetween.

The light-guide system 927 is formed of a condenser lens 954 disposed at the outgoing side of the outgoing section 946 for the blue optical flux B, an incoming-side reflecting mirror 971, an outgoing-side reflecting mirror 972, an intermediate lens 973 disposed between these reflecting mirrors, and a condenser lens 953 disposed before the light valve 925B. The blue optical flux B output from the outgoing section 946 is guided to the liquid-crystal apparatus 962B through the light-guide system 927 and modulated. Of the optical-path length of the optical flux of each color, that is, in the distance from the outgoing section for the optical flux W to each of the liquid-crystal apparatuses 962R, 962G, and 962B, that for the blue optical flux B is the longest, and therefore, the amount of lost light of the blue optical flux is the largest. With the light-guide system 927 interposed, the amount of lost light is suppressed.

The color optical fluxes R, G, and B passing through and being modulated by the light valves 925R, 925G, and 925B are incident on the color combining prism 910 and combined therein. The light combined by the color combining prism 910 is expanded and projected on the surface of the projection plane 100 disposed at a predetermined position, through the projection-lens unit 906.

In the present embodiment, since light-shielding layers are formed below TFTs in the liquid-crystal apparatuses 962R, 962G, and 962B, even if light projected from the liquid-crystal apparatuses 962R, 962G, and 962B and reflected from a projection optical system in the liquid-crystal projector, light reflected from the surface of the TFT array substrate when projected light passes, and a part of projected light which has been output from another liquid-crystal apparatus and passes through the projection optical system are incident from the TFT-array-substrate side as returning light, the channels of the pixel-electrode-switching TFTs are sufficiently shielded from such light.

Therefore, even when the color combining prism 910 suitable for making the display apparatus compact is used, it is not necessary to separately dispose a returning-light-prevention film between each of the liquid-crystal apparatuses 962R, 962G, and 962B and the color combining prism 910 and to apply returning-light-prevention processing to the polarizing means. Therefore, it is highly advantageous in terms of making the structure compact and simple.

Since the effect of returning light on the TFT channel regions is suppressed in the present embodiment, it is not necessary to directly attach the polarizing means 961R, 961G, and 961B, to which returning-light-prevention processing has been applied, to the liquid-crystal apparatuses. As shown in FIG. 7, it is possible to form the polarizing means separately from the liquid-crystal apparatuses. More specifically, it is possible that the polarizing means 961R, 961G, and 961B disposed at the outgoing sides are adhered to the color combining prism 910 and the polarizing means 960R, 960G, and 960B disposed at the incoming sides are adhered to the condenser lenses 951, 952, and 953. When polarizing means are attached to the color combining prism 910 or to the condenser lenses 951, 952, and 953 in this way, since the heat of the polarizing means is absorbed by the color combining prism 910 or by the condenser lenses 951, 952, and 953, a rise in temperature of the liquid-crystal apparatuses is suppressed to prevent their malfunction.

When the liquid-crystal apparatuses and the polarizing means are separately formed, air layers are generated between the liquid-crystal apparatuses and the polarizing means, although the air layers are not shown in the figure. When cooling means is provided therein to send air, such as cool air, to the area between the liquid-crystal apparatuses and the polarizing means, a rise in temperature of the liquid-crystal apparatuses is further suppressed to more positively prevent malfunction caused by the temperature rises of the liquid-crystal apparatuses.

In the above description, the electro-optical apparatus is the liquid-crystal apparatus. The electro-optical apparatus is not limited to the liquid-crystal apparatus. The present invention can also be applied to various electro-optical apparatuses, such as an electroluminescence display and a plasma display.

Industrial Applicability

As described above, according to the present invention, a reduction in display quality caused by an optical leakage current of a transistor is prevented, and the deterioration of the breakdown voltage between the source and the drain of a transistor formed of a monocrystalline silicon layer covered with an insulating film, caused by the substrate floating effect, is also prevented. In addition, the electrical characteristics of a device are made stable and are improved, and a transmissive electro-optical apparatus can obtain an appropriate aperture ratio.

1. An electro-optical apparatus having a plurality of scanning lines, a plurality of data lines which intersect with the plurality of scanning lines, a transistor connected to each scanning line and to each data line, and a pixel electrode connected to the transistor,
on a substrate in which a semiconductor layer is formed on a supporting substrate through an insulating film,
characterized in that the transistor is a p-type transistor having a fully-depleted channel layer.

2. An electro-optical apparatus having integrated peripheral circuits, a plurality of scanning lines, a plurality of data lines which intersect with the plurality of scanning lines, a transistor connected to each scanning line and to each data line, and a pixel electrode connected to the transistor
on a substrate in which a semiconductor layer is formed on a supporting substrate through an insulating film,
characterized in that the peripheral circuits are formed of transistors having partially-depleted channel layers, and
the transistor connected to the pixel electrode is a p-type transistor having a fully-depleted channel layer.

3. An electro-optical apparatus having integrated peripheral circuits, a plurality of scanning lines, a plurality of data lines which intersect with the plurality of scanning lines, a transistor connected to each scanning line and to each data line, and a pixel electrode connected to the transistor
on a substrate in which a semiconductor layer is formed on a supporting substrate through an insulating film,
characterized in that the peripheral circuits are formed of a combination of transistors having partially-depleted channel layers and of transistors having fully-depleted channel layers, and
the transistor connected to the pixel electrode is a p-type transistor having a fully-depleted channel layer.

4. An electro-optical apparatus having integrated peripheral circuits, a plurality of scanning lines, a plurality of data lines which intersect with the plurality of scanning lines, a transistor connected to each scanning line and to each data line, and a pixel electrode connected to the transistor
on a substrate in which a semiconductor layer is formed on a supporting substrate through an insulating film,
characterized in that the peripheral circuits are formed of a combination of n-type transistors having partially-depleted channel layers and of p-type transistors having fully-depleted channel layers, and
the transistor connected to the pixel electrode is a p-type transistor having a fully-depleted channel layer.

5. An electro-optical apparatus according to one of claims 1 to 4, characterized in that the semiconductor layer is made from monocrystalline silicon.

6. An electro-optical apparatus according to one of claims 1 to 4, characterized in that the semiconductor layer is made from polycrystalline silicon.

7. An electro-optical apparatus according to one of claims 1 to 4, characterized in that the supporting substrate is a transparent substrate.

8. An electro-optical apparatus according to one of claims 1 to 4, characterized in that the supporting substrate is a quartz substrate.

9. An electro-optical apparatus according to one of claims 1 to 4, characterized in that the supporting substrate is a glass substrate.

10. An electro-optical apparatus according to one of claims 1 to 4, characterized by further comprising a light-shielding layer between the supporting substrate and the semiconductor layer.

11. An electro-optical apparatus according to one of claims 1 to 4, characterized in that the film thickness of the fully-depleted channel layer falls in the range from 30 nm to 100 nm.

12. An electro-optical apparatus according to one of claims 1 to 11, characterized by further comprising:
opposite the surface on which the semiconductor layer is formed in the substrate acting as another substrate, one substrate; and
liquid crystal driven by the transistors formed in the semiconductor layer and sandwiched by the one substrate and the other substrate.

13. An electronic unit characterized by comprising:
a light source;
an electro-optical apparatus according to claim 12, to which light emitted from the light source is incident and in which modulation corresponding to image information is applied; and
projection means for projecting the light modulated by the electro-optical apparatus.
